(19) United States
(12) Patent Application Publication
(10) Pub. No.: US 2009/0007489 A1
(43) Pub. Date: Jan. 8, 2009

(54) Vehicle Door Comprising a Deceleration Function

(75) Inventors: Simon Kern, Darmstadt (DE); Juergen Maas, Kelkheim (DE); Bernd Seiler, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/793,525

(22) PCT Filed: Dec. 7, 2005
(86) PCT No.: PCT/EP2005/013096

§ 371 Date: Jul. 1, 2008

(30) Foreign Application Priority Data
Dec. 22, 2004 (DE) 10 2004 061 687.6

(51) Int. Cl. E05F 15/20; B60J 5/04

(52) U.S. Cl. 49/31

(57) ABSTRACT

The invention relates to a vehicle door comprising a braking function before a detected obstacle (3) and for damping the final position, which decelerates the movement of the vehicle door (2) by applying a braking torque, wherein an evaluation and control unit (7) determines the braking torque by evaluating an instantaneous door movement, which is sensed by a sensor system (6), or a sensed obstacle and actuates the damper (5) correspondingly. According to the invention, the braking function decelerates the vehicle door (2) aperiodically taking into account interference torques, wherein the evaluation and control unit (7) determines the braking torque for the braking function, in that during an opening process the vehicle door (2) reaches a target position with a speed with the value zero, and during a closing process reaches an end position (φ₀) with a predefined target speed, wherein the target position corresponds to a predefined maximum opening angle (φₘₐₓ) or a virtual stop which is determined by an obstacle (3) which is detected by the sensor system.

### BACKGROUND AND SUMMARY OF THE INVENTION

This invention relates to a vehicle door having a braking function.

If vehicle doors are opened carelessly, it is easy for collisions with obstacles to occur, resulting in damage to the door or to the obstacle. A frequently occurring scenario is people getting out of the vehicle in tight parking spaces or garages. In this context, it is often necessary to open the door as far as possible against the neighboring vehicle or the walls for it to be possible at all to get out of the vehicle. This requires a latching mechanism with variable latching which allows the door to be positioned precisely. With current latching mechanisms, which generally have only one or two permanently predefined latching positions for the door, this is not possible. The door often opens too wide or does not remain opened.

Doors with a fixed stop have a wide opening angle so that there is no collision protection in tight parking spaces/garages. Provided that a suitable sensor system can be used to detect an obstacle in the opening region of the door, it is possible to prevent a collision by means of a variable stop.

German document DE 42 24 132 A1 describes a door securing system, in particular for a motor vehicle door or a flap, in which the door is held in any desired intermediate position within the opening area. The door securing system comprises a piston cylinder unit which, by means of connecting elements, is connected on one side to the element to be moved and on the other side to the base element. The piston cylinder unit has a pressure pipe in which a working space filled with a damping medium is divided in two by a piston on a piston rod, wherein the piston rod is guided radially by a piston rod guide. A valve which is arranged inside a flow connection and blocks the volume region between the working spaces is actuated in such a way that, when a door movement impulse is applied at any desired point on the door, the blocking valve opens and remains opened irrespective of the pressure within the door securing system until the blocking valve is closed again when a braking impulse is applied to the door.

German document DE 197 54 167 A1 discloses a device for infinitely variable locking of a component which can pivot about an axis, in particular doors and flaps. The described device comprises at least one cylinder and a piston with an electrorheological or magnetorheological liquid, an electronic control system by means of which the electrical or magnetic field strength in the rheological liquid can be adjusted, and a device for sensing or inputting of a desired locking position. The electronic control system can be actuated as a function of the sensed or input locking position. If an obstacle is detected in the planned pivoting region by a camera during the opening process, an electronic evaluation system activates the electronic control system in such a way that the door is locked before the obstacle is reached.

The object of the invention is to make available a vehicle door with a braking function which has the smallest possible braking range in order to be able to intervene as late as possible in the door movement.

This invention achieves this object by making available a vehicle door with the claimed braking function.

Advantageous embodiments and developments of the invention are also claimed.

According to the invention, the braking function brakes a vehicle door aperiodically before a detected obstacle and for the purpose of end position damping taking into account interference torques. An evaluation and control unit determines a braking torque for the braking function by evaluating an instantaneous door movement, which is sensed by a sensor system, or a sensed obstacle, such that during an opening process the vehicle door reaches a target position with a speed with the value zero, and during a closing process reaches an end position with a predefined target speed, wherein the target position corresponds to a predefined maximum opening angle or a virtual stop which is determined by an obstacle which is detected by the sensor system.

As a result, the vehicle door is advantageously braked aperiodically before the mechanical end stops or an obstacle is reached, as a result of which damage, severe shaking, noise and vibrations are avoided. This provides a high quality impression of the vehicle and favors the service life of the accessory parts, in particular of electrical and electronic circuits which are arranged in the vehicle door, and prevents mechanical loading of the hinges. When the vehicle door opens, it is braked in such a way that it comes to rest just before the mechanical stop or before a detected obstacle and is held in a latched position. When the vehicle door closes, its speed is reduced in such a way that the vehicle door reliably engages in the lock but does not impact against the vehicle with an unnecessarily large amount of force.

In one refinement of the vehicle door according to the invention, the evaluation and control unit starts the braking function if a remaining braking distance drops below a calculated braking distance.

As a result of the virtual stop, i.e. the aperiodic braking of the vehicle door before a detected obstacle, the operator advantageously receives haptic feedback about the risk of collision with the detected obstacle.

In a further refinement of the vehicle door according to the invention, an observer circuit estimates the interference torques which are to be taken into account and which comprise, for example, torques which are caused by the wind or gravity.

The observer circuit estimates an angular acceleration, for example from the measured door opening angle signals, and compares it with a real acceleration.

The evaluation and control unit determines the required braking distance Δφ_{Brems} as a function of a desired braking torque \tilde{M}_{b,soll}, for example with an equation (1) for an opening process, and with an equation (2) for a closing process, and with J_{d} representing the moment of mass inertia of the vehicle door.

$$\begin{matrix}{Δϕ}_{Brems} = \frac{1}{2} \frac{{J}_{d} \cdot {\dot{ϕ}}_{0 , k}^{2}}{{\tilde{M}}_{b , soll}} for ( \dot{ϕ} > 0 ) & ( 1 ) \\ {Δϕ}_{Brems} = - \frac{{J}_{d}}{2 {\tilde{M}}_{b}} ( {\dot{ϕ}}^{2} - {\dot{ϕ}}_{stop}^{2} ) for ( \dot{ϕ} < 0 ) & ( 2 )\end{matrix}$$

The evaluation and control unit determines the braking torque \tilde{M}_{b} as a function of the remaining braking distance (φₛₜₒₚ−φ_{0,k}), the speed \dot{φ} of the door and the moment of mass inertia J_{d} with an equation (3) for an opening process, and with an equation (4) for a closing process.

$$\begin{matrix}{\tilde{M}}_{b , k} = \frac{1}{2} \frac{{J}_{d} \cdot {\dot{ϕ}}_{0 , k}^{2}}{( {ϕ}_{stop} - {ϕ}_{0 , k} )} for \dot{ϕ} > 0 & ( 3 ) \\ {\tilde{M}}_{b} = \frac{{J}_{d} ( {\dot{ϕ}}^{2} - {\dot{ϕ}}_{stop}^{2} )}{2 ( ϕ - {ϕ}_{stop} )} for \dot{ϕ} < 0 & ( 4 )\end{matrix}$$

In the equations (1) to (4), φ₀ stands for the starting position and φ₀ stands for the starting speed of the trajectory during the opening process and φₛₜₒₚ and \dot{φ}ₛₜₒₚ stand for the desired end state of the trajectory during the opening and closing processes.

In a further refinement of the vehicle door according to the invention, the evaluation and control unit carries out the braking function during an opening process or a closing process for the smallest possible braking range, the braking range for the opening process being defined by (φₛₜₒₚ−Δφ_{Brems})≦φ≦φₛₜₒₚ and for the closing process by φₛₜₒₚ≦φ≦(φₛₜₒₚ+Δφ_{Brems}).

Various appropriate refinements which result from any desired combination of the subject matters of the dependent claims are not explicitly specified. However, this is intended to include all those that are associated with the invention.

Advantageous embodiments of the invention are illustrated in the drawings and will be described below.

### BRIEF DESCRIPTION OF THE DRAWINGS

FIG. 1 shows a schematic block circuit diagram of the components of a vehicle door which are essential to the invention,

FIG. 2 shows a more detailed block circuit diagram of the vehicle door from FIG. 1,

FIG. 3 shows a schematic illustration of the opening area of a vehicle door,

FIG. 4 shows a flowchart of a braking function for the vehicle door from FIG. 1,

FIG. 5 shows a schematic illustration of a model for the vehicle door from FIG. 1,

FIG. 6 shows a block diagram of a control circuit for the braking method from FIG. 4,

FIG. 7 shows a schematic block diagram of an observer for the control loop from FIG. 6, and

FIG. 8 shows a schematic state diagram of a vehicle door with a logically combined comfort function.

### DETAILED DESCRIPTION OF THE INVENTION

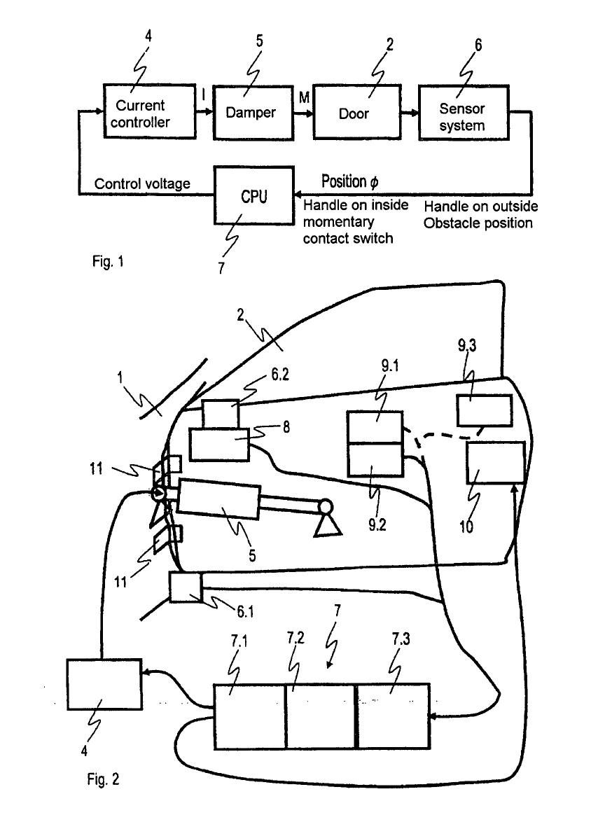

As is apparent from FIG. 1, a vehicle door 2 according to the invention comprises a sensor system 6 for sensing the door movement, an evaluation and control unit 7 for evaluating the sensed door movement and for actuating a damper 5 by means of an actuator 4, with the damper influencing the movement of the vehicle door 2 by means of a set torque M. The evaluation and control unit 7 outputs, for example, a control voltage U which is converted by the actuator 4 into a current I. In addition to the sensing of the door movement, the sensor system 6 can also comprise sensors for monitoring an internal door handle or external door handle or for detecting obstacles in the opening area of the vehicle door 2.

FIG. 2 shows a more detailed block circuit diagram of the vehicle door 2 with a braking function for a vehicle 1. As is apparent from FIG. 2, the vehicle door 2 comprises hinges 11, the damper 5 with the actuator 4 which is embodied as a current controller and which is actuated by the evaluation and control unit 7, an internal handle 9.1, an external handle 9.3, a momentary contact switch 9.2 and a unit 10 for unlocking the door lock 10, which unit 10 is activated by the momentary contact switch 9.2, arranged in the surroundings of the internal handle 9.1, by means of the evaluation and control unit 7. In order to evaluate the sensor signals and to output control signals, the evaluation and control unit 7 comprises a CPU 7.2 and an analog/digital converter 7.3 which conditions the received sensor signals for processing in the CPU 7.2, and a digital/analog converter 7.1 which correspondingly conditions the control signals from the CPU for outputting. The evaluation and control unit additionally has digital inputs and outputs for receiving and for outputting.

As is also apparent from FIG. 2, the sensor system 6 comprises a position sensor 6.1, which detects the opening angle φ of the vehicle door and transmits a corresponding signal to the evaluation and control unit 7, and a digital laser scanner 6.2 with associated control unit 8 for detecting obstacles. Optionally, further sensors can be arranged on the internal handle or external handle 9.1, 9.3 of the vehicle door 2 and be connected to the evaluation and control unit 7. These sensors detect activation of the associated handle 9.1, 9.3 and communicate it to the evaluation and control unit 7.

The illustrated hinges 11 of the vehicle door 2 do not have a fixed latching means but rather permit low-force movement of the vehicle door independently of position. The hinges 11 are embodied in such a way that the associated vehicle door 2 engages in the lock without the action of external forces in a first segment 400 of the opening area of the vehicle door 2 from an initial position, which corresponds to a minimum opening angle, up to a first opening angle φₘᵢₙ which is, for example, approximately 15°, that is to say is accelerated toward relatively small positions in the direction of the initial position.

The damper 5 which is used has low friction in the enabled state, and its holding force corresponds to a holding/braking torque of approximately 100 Nm. The damper 5 is embodied in such a way that it can be satisfactorily actuated and responds quickly to the control signals.

Various designs and functional principles are available for selection for the implementation of the braking function for the damper 5. In principle, the dampers 5 are divided into rotary action and translatory action dampers. The possible actuators 4 for actuating the dampers 5 can be classified as having electrohydraulic, electromechanical, magnetorheological and electrorheological functional principles. Active actuator units such as electric motors which act in a rotary or linear fashion and hydraulic drives can also be used.

For the braking function, the position of the vehicle door 2, which is sensed, for example, as an opening angle φ by the position sensor 6.1, is evaluated. By suitable filtering and differentiation of the signal of the position sensor 6.1, it is possible to estimate the angular speed or the angular acceleration. The low pass filtering which is used constitutes here a compromise of a signal which is as “smooth” as possible and which has minimized noise, and a sufficiently unfalsified system movement with short delays. Angle sensors which operate according to the Hall principle or are embodied as rotary potentiometers can be used as position sensors 6.1. Furthermore, the linearly acting length measuring systems, with which the position of the vehicle door 2 can be determined, can also be used. In one particularly advantageous embodiment of the vehicle door 2, it is not the displacement of the damper 5 but rather the position of the vehicle door 2 itself which is sensed, including the movements which occur in the mechanism of the vehicle door 2 and of the damper 5 owing to the elasticities. If the position sensor 6.1 is integrated into the damper 5, elastic resilience is provided explicitly in the structure of the damper 5 and permits the sensor 6.1 to sense a movement of the vehicle door 2 within the scope of its resilience even when the damper 5 is blocked.

In one possible embodiment, an activation request can be detected which is made by means of a mechanical momentary contact switch which is let into the external handle 9.3 of the vehicle door 2 and with which it is detected whether the operator grasps the handle 9.3, or which is made by means of a capacitive sensor on the internal handle 9.1 of the vehicle door 2. In addition to these sensors, which detect the driver's hand on the handle 9.1, 9.3, a further momentary contact switch can be arranged on the upper end of the internal handle. It is also possible to use other sensors to register the activation request. By means of the sensors it is detected whether the driver grasps the internal or external door handle 9.1 or 9.3. If this is the case, the latching force can be switched off so that the driver can move the vehicle door 2 out of its latched position without applying force.

The sensor 6.2 for detecting obstacles detects the position of objects 3 in the opening area of the vehicle door 2, either relative to the vehicle 1 or relative to the current position of the vehicle door 2. In the illustrated exemplary embodiment, the obstacle sensor 6.2 is embodied as a laser scanner with an oscillating deflecting mirror. The laser scanner 6.2 is arranged on the vehicle door 2 in such a way that a plane is scanned which passes through the hinge axis but has an angle which corresponds to the surface of the vehicle door 2. As a result, obstacles 3 which are approaching the vehicle door 2 can be detected in good time. With such an arrangement of the obstacle sensor 6.2, no information about the precise position of the obstacle 3 in the space is required since the distance to the vehicle door 2 can be determined unambiguously in the relevant angle coordinates.

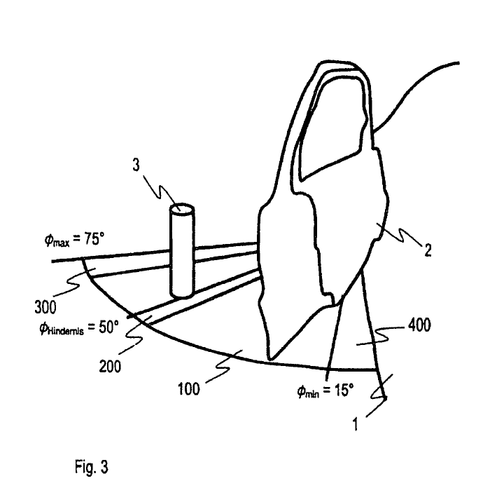

FIG. 3 is a schematic illustration of the opening area of the vehicle door 2. As is apparent from FIG. 3, the opening area comprises a functional area 100 for a variable latching function. If the vehicle door 2 is brought to a standstill in any desired position within the functional area 100 of the variable latching system, the vehicle door 2 can be stopped precisely at this position by the holding torque of the damper 5. In the first segment 400 of the opening area of the vehicle door from the initial position up to the opening angle φₘᵢₙ=15° the vehicle door 2 is not latched. As a result of the embodiment of the hinges 11 which is described above, the vehicle door 2 engages in the lock when it is positioned within the first segment 400 of the opening area. The opening area of the vehicle door 2 which is illustrated in FIG. 3 is normally bounded by a maximum possible opening angle φₘₐₓ=75°. However, since there is an obstacle 3 in the opening area and said obstacle is detected by the obstacle sensor 6.2, the maximum possible opening angle is limited, for example, to the angle φ_{Hindernis}=50° in order to prevent damage to the vehicle door 2. As a result of the obstacle 3 which is detected in the pivoting range, the functional area 100 of the variable latching function is limited to the opening angle φ_{Hindernis}=50° which is predefined by the obstacle 3.

The evaluation and control unit 7 carries out the braking function for the vehicle door 2 in the braking area 200 in the form of a virtual stop before the obstacle detected 3. If there is no obstacle in the opening area of the vehicle door 2, the evaluation and control unit 7 carries out the braking function in the region 300 before the mechanical end stop of the vehicle door 2. By means of the braking function, the vehicle door is braked before it reaches the mechanical end stops, in order to prevent severe shaking and loud noises. This provides a high quality impression of the vehicle 1, lengthens the service life of the accessory parts, in particular of electrical and electronic circuits arranged in the vehicle door 2, and reduces the mechanical loading of the hinges 11.

When the vehicle door 2 opens, it is braked in such a way that it comes to rest just before the mechanical stop and is held in a latched position. When the vehicle door 2 closes, the speed of the vehicle door is braked in such a way that the vehicle door 2 reliably engages in the lock but does not impact against the vehicle door 2 with an unnecessarily large amount of force.

As a result of the braking function according to the invention, the vehicle door 2 reaches a predefined end position during opening with the speed zero, and in the case of end position damping it does so with a predefined target speed in the closing direction. In addition, the braking function can be used to brake the vehicle door 2 at the transition into any desired latched position within the function area 100 or when a predefined maximum speed is exceeded. If the braking process is carried out with a torque which is as constant as possible, the braking process appears natural. In order to cause no oscillation, or only small oscillation, of the vehicle door after the end stop is reached after the braking process, the smallest possible braking torque should be selected.

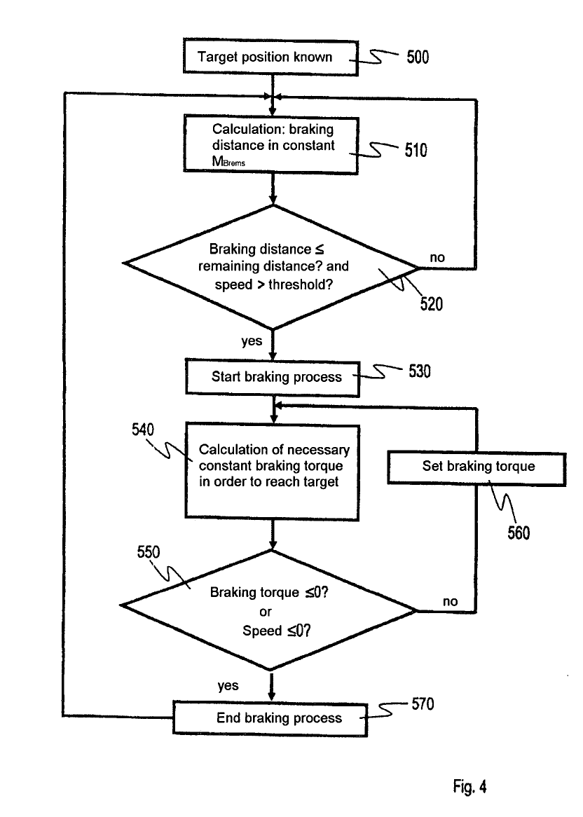

FIG. 4 shows a flowchart of the braking function for the vehicle door 2. The target position which in the case of an opening process is predefined by the mechanical end stop or by a detected obstacle in the opening area, or in the case of a closing process is predefined by the end position of the vehicle door 2, is determined in step 500. In step 510, the braking distance is calculated with a constant braking torque as a function of the specific target position. In step 520 it is checked whether the calculated braking distance is shorter than or equal to the remaining distance and whether the instantaneous speed exceeds a predefined threshold value. In the step 530, the braking function for the vehicle door 2 is started if the remaining braking distance up to the target position is less than the calculated braking distance which is required to brake the door with a desired constant braking torque. Starting from this time, the braking torque is recalculated at every scanning step in step 540, which is necessary in order to reach the target position according to the predefined speed values. In an ideal case, the newly calculated braking torque always corresponds to the desired braking torque. The recalculation of the braking torque serves to compensate acting interference torques. In step 550 it is checked whether the predefined target values have been reached. If this is not the case, in step 560 the calculated braking torque is set and the system subsequently branches to step 540, and otherwise the braking process is ended at step 570.

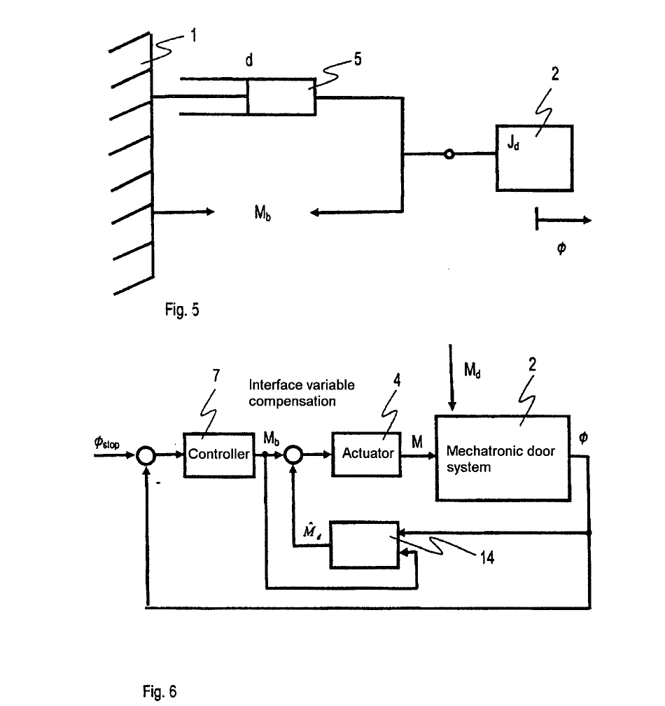

In order to calculate the necessary braking distance and the braking torque, the simplified door model which is illustrated in FIG. 5 is used. In order to keep the order of the model small, the elasticities which occur in the real vehicle door 2 are ignored.

The model illustrated in FIG. 5 is described by the differential equation (5)

J_{d}\dot{φ}+d\dot{φ}+M_{b}sign(\dot{φ})=0 (5)

which leads in the state level (\dot{φ} over φ) to the following relationship:

$$\begin{matrix}ϕ - {ϕ}_{0} = \frac{{J}_{d}}{{\tilde{M}}_{b}} \frac{1}{2} ( {\dot{ϕ}}_{0}^{2} - {\dot{ϕ}}^{2} ) for an opening process ( \dot{ϕ} > 0 ) & ( 6 ) \\ {ϕ}_{stop} - ϕ = - \frac{{J}_{d}}{2 {\tilde{M}}_{b}} ( {\dot{ϕ}}^{2} - {\dot{ϕ}}_{stop}^{2} ) for a closing process ( \dot{ϕ} < 0 ) , & ( 7 )\end{matrix}$$

where φ₀ stands for the starting position and φ₀ stands for the starting speed of the trajectory during the opening process, and φₛₜₒₚ and \dot{φ}ₛₜₒₚ stand for the desired end state of the trajectory during the opening and closing processes. On the basis of this description, the required braking distance is obtained as a function of the desired braking torque from the equations (1) and (2) as follows:

$$\begin{matrix}{Δϕ}_{Brems} = \frac{1}{2} \frac{{J}_{d} \cdot {\dot{ϕ}}_{0 , k}^{2}}{{\tilde{M}}_{b , soll}} for \dot{ϕ} > 0 & ( 1 ) \\ {Δϕ}_{Brems} = - \frac{{J}_{d}}{2 {\tilde{M}}_{b}} ( {\dot{ϕ}}^{2} - {\dot{ϕ}}_{stop}^{2} ) for \dot{ϕ} < 0. & ( 2 )\end{matrix}$$

From the same approach the equations (3) and (4) for the braking torque when opening as a function of the remaining braking distance, the speed of the vehicle door and the moment of mass inertia are obtained as follows:

$$\begin{matrix}{\tilde{M}}_{b , k} = \frac{1}{2} \frac{{J}_{d} \cdot {\dot{ϕ}}_{0 , k}^{2}}{( {ϕ}_{stop} - {ϕ}_{0 , k} )} for \dot{ϕ} > 0 & ( 3 ) \\ {\tilde{M}}_{b} = \frac{{J}_{d} ( {\dot{ϕ}}^{2} - {\dot{ϕ}}_{stop}^{2} )}{2 ( ϕ - {ϕ}_{stop} )} for \dot{ϕ} < 0. & ( 4 )\end{matrix}$$

For reasons of better comfort, this control process should only intervene in the movement of the vehicle door 2 in a defined braking area (φₛₜₒₚ−Δφ_{Brems})≦φ≦φₛₜₒₚ which is as small as possible during the opening process or φₛₜₒₚ≦φ≦(φₛₜₒₚ+Δφ_{Brems}) during the closing process before the end position is reached. This advantageously permits the driver to open the vehicle door in the usual unbraked fashion.

The friction of the door mechanism is left out of the model in FIG. 5. This has the result during the braking process that the vehicle door is in reality braked slightly more strongly than the braking function describes. The continuous correction in the scanning steps according to the braking function from FIG. 4 ensures that the braking torque becomes negligibly small when the end position is reached, and as a result no harmonics occur owing to the inherent elasticities.

In order to compensate interference torques which occur, a control which is illustrated in FIG. 6 with an observer structure 14 is used, which observer structure 14 can estimate an acting interference torque so that the interference torque can be taken into account in the control process. As is apparent from FIG. 6, the control loop for the braking function from FIG. 4 comprises a controller whose function is carried out by the evaluation and control unit 7, an actuator 4 for influencing the mechatronic door system 2 via the damper 5, and the observer structure 14 whose function can likewise be carried out by the evaluation and control unit 7.

In order to observe the interference torque M_{d} which cannot be measured and which acts on the mechatronic door system 2, and possibly to compensate it by means of suitable feedback, the observer structure 14 for estimating this variable is presented below. All kinds of torque which can be applied both by the driver when opening or closing the vehicle door 2 and by the acting wind or gravity are possible as interference acting on this door model. It is not possible to determine the cause of the inference torques with the sensor system 6 used here. Generally this requires a door model which runs parallel to the real system and which can infer all the other system influences from the measurable variables such as the applied braking torque M_{b} and the position φ for the vehicle door 2. The simplified door model from FIG. 5 without twisting of the A pillar is used for this.

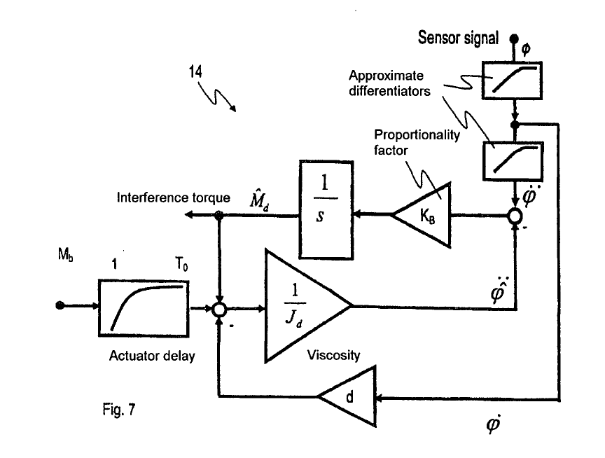

FIG. 7 shows a possible approach for implementing the observer structure 14 from FIG. 6 in which the angular acceleration \ddot{φ} is estimated from the measurable sensor signals and adjusted with the real acceleration. The observer structure 14 is based on the adjustment of the angular accelerations which occur to the real vehicle door 2 with the angular acceleration of the door model from FIG. 5.

The target position for the braking of the vehicle door 2 is, according to standard practice, the maximum opening angle of the vehicle door 2. As a result, the vehicle door 2 is braked in the braking area 300 before the mechanical stop is reached. If an obstacle 3 is detected in the opening area by a special surroundings sensor system 6.2, the target position is set to the value just before the obstacle 3.

In order to permit the vehicle door 2 to open despite the fact that an obstacle 3 has been detected, the virtual stop can be switched off by activating the momentary contact switches on the internal or external handle 9.1, 9.3, respectively. As a result, the signal of the sensor 6.2 is ignored and the target angle for the braking function is set to the maximum opening angle. This procedure may be necessary in particular if the vehicle door 2 is to be opened by a person who is just outside the vehicle 1 and who is incorrectly detected as an obstacle 3 by the sensor system 6.2.

The end position damping of the braking function when the vehicle door 2 closes permits the closing speed of the vehicle door 2 to be reduced to a desired setpoint value just before closing occurs. This ensures that the vehicle door 2 engages in the lock sufficiently quickly in order to close completely but not unnecessarily more quickly. This avoids noise when the vehicle door 2 closes and unnecessary shock loading of the vehicle door 2, lock system, chassis 1 and above all the electronic and electrical circuits.

The end position damping for the closing of the vehicle door 2 brakes the vehicle door 2 so that the vehicle door 2 has a defined maximum speed when the door lock is reached. For this purpose, the braking function for the closing movement is implemented with a target speed \dot{φ} stop.

In order to give the vehicle occupant haptic feedback that the vehicle door 2 is being opened against a detected obstacle 3 and in order to avoid a collision through further opening, a virtual stop is implemented by control technology before the position of the detected obstacle 3.

When the threshold value for the door position is exceeded, the damper 5 is set to maximum holding force. As a result, during the opening process the vehicle occupant senses a resistance, i.e. a stop, and the vehicle door 2 cannot be opened further. The holding force is switched off again if the door position drops below the threshold value, the door speed drops below a negative threshold value, i.e. the vehicle door 2 carries out a closing movement, or the vehicle occupant grasps one of the sensed door handles 9.1, 9.3.

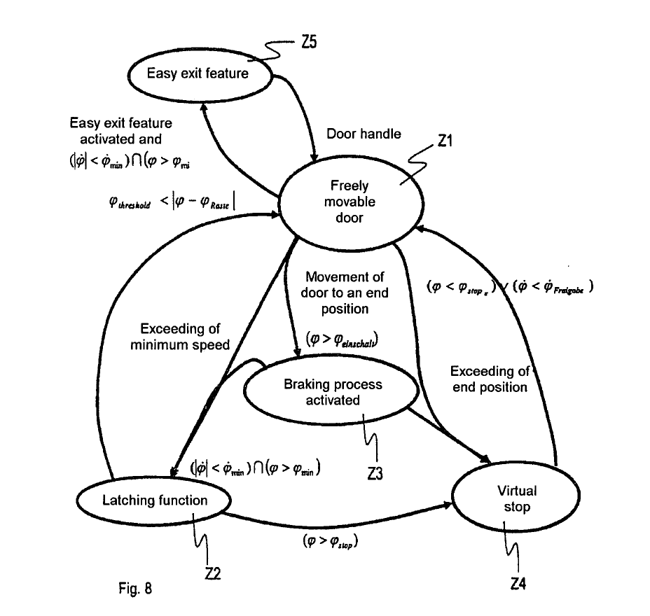

FIG. 8 shows a state diagram of the vehicle door 2 with a combination of a plurality of comfort functions. As is clear from FIG. 8, the vehicle door 2 is freely movable in the first state Z1 and is actively held in a second state Z2 in any desired latched position within the opening area of the vehicle door 2 by means of the variable latching function. When an obstacle is detected, the vehicle door 2 assumes a fourth state Z4 in the form of a virtual stop which is assumed as a function of the distance between the vehicle door 2 and the detected obstacle. In the third state Z3 which has already been described, the vehicle door 2 can be braked actively by a braking function at the transition into the latched state Z2 or into the virtual stop Z4 or into one of the end positions of the opening area. The braking function in the state Z3 allows the vehicle door 2 to reach a predefined target position when opening with the speed zero and with a predefined target speed in the closing direction in the case of end stop damping. The braking function in the state Z3 can be activated during an opening or closing movement, in addition to the limitation of the door speed. The braking function is activated in this case if the door speed exceeds a predefined threshold value. As a further comfort function it is possible to use a manual activation means 9.2 arranged in the surroundings of the internal handle 9.1 of the door to unlock a vehicle lock electronically before the vehicle door 2 is opened.

As is further apparent from FIG. 8, the vehicle door 2 has a fifth state Z5 which is activated by a predefined activation and acts as an easy exit feature, with which the vehicle door 2 is held in a desired position with a maximum latching torque until the easy exit feature is deactivated again.

The aforesaid comfort functions which cause transitions between the first to fourth states are compatible with one another and can be combined with one another as desired, i.e. their activation and deactivation conditions are clearly defined and can be combined without further measures.

Since the variable latching function and the easy exit feature have the same switching conditions for the activation of the holding force, these two functions cannot be implemented concurrently in an unlimited fashion. One possible implementation could have the variable latching function as a standard function and the means for providing assistance for getting out of the vehicle could be activated, for example, by actuating a specific switch.

1-8. (canceled)

9. A vehicle door having a braking function relative to a detected obstacle and for damping movement into a final position, which decelerates the movement of the vehicle door by applying a braking torque, comprising:
a sensor system that senses an instantaneous door movement,
a damper, and
an evaluation and control unit that determines the braking torque by evaluating the instantaneous door movement, which is sensed by the sensor system or as a function of the detected obstacle detected by the sensor system, and actuates the damper correspondingly,
wherein the braking function decelerates the vehicle door aperiodically taking into account interference torques,
wherein the evaluation and control unit determines the braking torque for the braking function,
wherein, during an opening process, the vehicle door reaches a target position with a speed with the value zero, and, during a closing process, reaches an end position with a predefined target speed, and
wherein the target position corresponds to a predefined maximum opening angle or a virtual stop which is determined by the obstacle detected by the sensor system.

10. The vehicle door as claimed in claim 9, wherein the evaluation and control unit starts the braking function when a remaining braking distance drops below a calculated braking distance.

11. The vehicle door as claimed in claim 9, wherein the virtual stop generates haptic feedback about a risk of a collision of the vehicle door with the obstacle.

12. The vehicle door as claimed in claim 9, wherein an observer circuit estimates the interference torques comprising torques caused by wind or gravity that are to be taken into account.

13. The vehicle door as claimed in claim 12, wherein the observer circuit estimates an angular acceleration from measured door opening angle sensor signals and adjusts it with a real acceleration.

14. The vehicle door as claimed in claim 9, wherein the evaluation and control unit determines the required braking distance as a function of a desired braking torque according to the equation:
$${Δϕ}_{Brems} = \frac{1}{2} \frac{{J}_{d} \cdot {\dot{ϕ}}_{0 , k}^{2}}{{\tilde{M}}_{b , soll}}$$
for an opening process (\dot{φ}>0), and
$${Δϕ}_{Brems} = - \frac{{J}_{d}}{2 {\tilde{M}}_{b}} ( {\dot{ϕ}}^{2} - {\dot{ϕ}}_{stop}^{2} )$$
for a closing process (\dot{φ}<0).

15. The vehicle door as claimed in claim 9, wherein the evaluation and control unit determines the braking torque as a function of the remaining braking distance, the speed of the door and the moment of mass inertia according to the equation:
$$\begin{matrix}{\tilde{M}}_{b , k} = \frac{1}{2} \frac{{J}_{d} \cdot {\dot{ϕ}}_{0 , k}^{2}}{( {ϕ}_{stop} - {ϕ}_{0 , k} )} for \dot{ϕ} > 0 , \\ and \\ {\tilde{M}}_{b} = \frac{{J}_{d} ( {\dot{ϕ}}^{2} - {\dot{ϕ}}_{stop}^{2} )}{2 ( ϕ - {ϕ}_{stop} )} for \dot{ϕ} < 0.\end{matrix}$$

16. The vehicle door as claimed in claim 14, wherein the evaluation and control unit carries out the braking function during an opening process or a closing process for the smallest possible braking range, and wherein the braking range for the opening process is defined by (φₛₜₒₚ−φ_{Brems})≦φ≦φₛₜₒₚ and for the closing process is defined by φₛₜₒₚ≦φ≦(φₛₜₒₚ+Δφ_{Brems}).

17. The vehicle door as claimed in claim 15, wherein the evaluation and control unit carries out the braking function during an opening process or a closing process for the smallest possible braking range, and wherein the braking range for the opening process is defined by (φₛₜₒₚ−φ_{Brems})≦φ≦φₛₜₒₚ and for the closing process is defined by φₛₜₒₚ≦φ≦(φₛₜₒₚ+Δφ_{Brems}).

18. The vehicle door as claimed in claim 10, wherein the virtual stop generates haptic feedback about a risk of a collision of the vehicle door with the obstacle.

19. The vehicle door as claimed in claim 10, wherein an observer circuit estimates the interference torques comprising torques caused by wind or gravity that are to be taken into account.

20. The vehicle door as claimed in claim 11, wherein an observer circuit estimates the interference torques comprising torques caused by wind or gravity that are to be taken into account.

21. The vehicle door as claimed in claim 19, wherein the observer circuit estimates an angular acceleration from measured door opening angle sensor signals and adjusts it with a real acceleration.

22. The vehicle door as claimed in claim 20, wherein the observer circuit estimates an angular acceleration from measured door opening angle sensor signals and adjusts it with a real acceleration.

23. The vehicle door as claimed in claim 10, wherein the evaluation and control unit determines the required braking distance as a function of a desired braking torque according to the equation:
$${Δϕ}_{Brems} = \frac{1}{2} \frac{{J}_{d} \cdot {\dot{ϕ}}_{0 , k}^{2}}{{\tilde{M}}_{b , soll}}$$
for an opening process (\dot{φ}>0), and
$${Δϕ}_{Brems} = - \frac{{J}_{d}}{2 {\tilde{M}}_{b}} ( {\dot{ϕ}}^{2} - {\dot{ϕ}}_{stop}^{2} )$$
for a closing process (\dot{φ}<0).

24. The vehicle door as claimed in claim 11, wherein the evaluation and control unit determines the required braking distance as a function of a desired braking torque according to the equation:
$${Δϕ}_{Brems} = \frac{1}{2} \frac{{J}_{d} \cdot {\dot{ϕ}}_{0 , k}^{2}}{{\tilde{M}}_{b , soll}}$$
for an opening process (\dot{φ}>0), and
$${Δϕ}_{Brems} = - \frac{{J}_{d}}{2 {\tilde{M}}_{b}} ( {\dot{ϕ}}^{2} - {\dot{ϕ}}_{stop}^{2} )$$
for a closing process (\dot{φ}<0).

25. The vehicle door as claimed in claim 12, wherein the evaluation and control unit determines the required braking distance as a function of a desired braking torque according to the equation:
$${Δϕ}_{Brems} = \frac{1}{2} \frac{{J}_{d} \cdot {\dot{ϕ}}_{0 , k}^{2}}{{\tilde{M}}_{b , soll}}$$
for an opening process (\dot{φ}>0), and
$${Δϕ}_{Brems} = - \frac{{J}_{d}}{2 {\tilde{M}}_{b}} ( {\dot{ϕ}}^{2} - {\dot{ϕ}}_{stop}^{2} )$$
for a closing process (\dot{φ}<0).

26. The vehicle door as claimed in claim 10, wherein the evaluation and control unit determines the braking torque as a function of the remaining braking distance, the speed of the door and the moment of mass inertia according to the equation:
$$\begin{matrix}{\tilde{M}}_{b , k} = \frac{1}{2} \frac{{J}_{d} \cdot {\dot{ϕ}}_{0 , k}^{2}}{( {ϕ}_{stop} - {ϕ}_{0 , k} )} for \dot{ϕ} > 0 , \\ and \\ {\tilde{M}}_{b} = \frac{{J}_{d} ( {\dot{ϕ}}^{2} - {\dot{ϕ}}_{stop}^{2} )}{2 ( ϕ - {ϕ}_{stop} )} for \dot{ϕ} < 0.\end{matrix}$$

27. The vehicle door as claimed in claim 11, wherein the evaluation and control unit determines the braking torque as a function of the remaining braking distance, the speed of the door and the moment of mass inertia according to the equation:
$$\begin{matrix}{\tilde{M}}_{b , k} = \frac{1}{2} \frac{{J}_{d} \cdot {\dot{ϕ}}_{0 , k}^{2}}{( {ϕ}_{stop} - {ϕ}_{0 , k} )} for \dot{ϕ} > 0 , \\ and \\ {\tilde{M}}_{b} = \frac{{J}_{d} ( {\dot{ϕ}}^{2} - {\dot{ϕ}}_{stop}^{2} )}{2 ( ϕ - {ϕ}_{stop} )} for \dot{ϕ} < 0.\end{matrix}$$

28. The vehicle door as claimed in claim 12, wherein the evaluation and control unit determines the braking torque as a function of the remaining braking distance, the speed of the door and the moment of mass inertia according to the equation:
$$\begin{matrix}{\tilde{M}}_{b , k} = \frac{1}{2} \frac{{J}_{d} \cdot {\dot{ϕ}}_{0 , k}^{2}}{( {ϕ}_{stop} - {ϕ}_{0 , k} )} for \dot{ϕ} > 0 , \\ and \\ {\tilde{M}}_{b} = \frac{{J}_{d} ( {\dot{ϕ}}^{2} - {\dot{ϕ}}_{stop}^{2} )}{2 ( ϕ - {ϕ}_{stop} )} for \dot{ϕ} < 0.\end{matrix}$$
